(19) United States
(12) Patent Application Publication
(10) Pub. No.: US 2026/0128296 A1
(43) Pub. Date: May 7, 2026

(54) SYNTHESIS OF DISORDERED ROCK SALT (DRX) CATHODE MATERIALS FOR LI-ION BATTERIES

(71) Applicant: UT-Battelle, LLC, Oak Ridge, TN (US)

(72) Inventors: Ethan C. Self, Oak Ridge, TN (US); Beth L. Armstrong, Oak Ridge, TN (US); Matthew S. Chambers, Oak Ridge, TN (US)

(21) Appl. No.: 19/374,473

(22) Filed: Oct. 30, 2025

Related U.S. Application Data
(60) Provisional application No. 63/715,138, filed on Nov. 1, 2024.

(51) Int. Cl. H01M 4/505; C01G 45/22; H01M 10/0525

(52) U.S. Cl. CPC H01M 4/505; C01G 45/22; C01P 2002/50; C01P 2006/40; H01M 10/0525

(57) ABSTRACT

A method of making a disordered rock salt cathode material for lithium-ion batteries includes performing combustion synthesis with an aqueous solution of metal-containing compounds. The method may include a two-stage process having a first stage followed by a second stage. The first stage includes performing combustion synthesis to obtain a metal oxide precursor. The second stage includes one or more of lithiating, fluorinating, and annealing the metal oxide precursor to obtain a disordered rock salt (DRX) oxide or oxyfluoride. The obtained disordered rock salt (DRX) may have a chemical composition Li₁₊ₓMn_{y}TM_{1-x-y}O_{2-z}F_{z} wherein 0≤x≤0.3, 0.4≤y≤1, 0≤z≤0.3, and TM is one or more transition metals selected from a group of Ti, Zr, Mo, Nb, and V. A lithium-ion battery cathode including a disordered rock salt cathode material and a lithium-ion battery including the lithium-ion battery cathode are also provided.

### CROSS-REFERENCE TO RELATED APPLICATIONS

This application claims the benefit of U.S. Provisional Application No. 63/715,138, filed Nov. 1, 2025, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to a method of synthesizing disordered rock salt (DRX) materials for battery cathodes and other applications.

### BACKGROUND OF THE INVENTION

Lithium-ion (Li-ion) batteries are widely utilized in a range of applications including portable electronics, electric vehicles, and grid storage. The cost and energy density of Li-ion batteries are largely influenced by the cathode material selection. State-of-the-art layered oxides (e.g., LiNiₓMn_{y}Co_{1-x-y}O₂ (NMC) and LiNiₓCo_{y}Al_{1-x-y}O₂ (NCA)) exhibit high operating voltages (greater than 3.8 V vs. Li/Li⁺) and reversible capacities (up to 220 mA h g⁻¹), but their over-reliance on critical resources, namely nickel (Ni) and cobalt (Co), presents considerable problems in developing sustainable supply chains. Co/Ni-free alternatives, including olivine LiFePO₄ and spinel LiMn₂O₄, have been commercialized, but these materials have significantly lower energy density, highlighting the need for new cathode chemistries based on earth-abundant transition metals.

Li-excess disordered rock salt (DRX) oxides represent a promising class of materials for next-generation Li-ion cathodes. DRX materials adopt the cubic Fm-3m rock salt structure, where Li⁺ and transition metals occupy the cation site, and O²⁻ anions occupy the anion site. Typically, these materials contain both redox-active transition metal(s) (e.g., manganese (Mn) and nickel (Ni)) and d⁰ transition metal(s) (e.g., Ti⁴⁺, Zr⁴⁺, and Nb⁵⁺), the latter stabilizing the DRX structure. Compared to conventional Li-ion cathodes, DRX materials exhibit broad compositional flexibility, and their disordered nature may provide other advantages such as smaller volume changes during cycling. They have been reported with impressive performance including specific capacities greater than or equal to 300 mA h g⁻¹ and specific energies of approximately 1000 W h kg⁻¹. Their electrochemical performance can be further improved by partially substituting O²⁻ with F⁻, which has been widely investigated for Mn/Ti-based compositions (e.g., Li₁₊ₓMn_{y}Ti_{1-x-y}O_{2-z}F_{z}). In addition to improving oxidative stability, F-substitution has been shown to increase Lit mobility via formation of percolating 0-TM channels in Li_{1.2}Ti_{0.35}Ni_{0.35}Nb_{0.1}O_{1.8}F_{0.2}. On the other hand, it has been demonstrated that fluorination levels of greater than 10% (i.e. 0.2 mol F per DRX formula unit) hinder Li⁺ percolation compared to the pure oxide DRX, but Li⁺ mobility increases at higher fluorination levels (greater than 15%). It has also been demonstrated for Mn-rich DRX (e.g., Li₁₊ₓMn_{y}Ti_{1-x-y}O_{2-z}F_{z}, y≥0.5), the capacity and cycling stability mostly depend on the Mn content, while fluorination plays a secondary role.

Despite their promising attributes, a significant limitation of DRX cathodes is the lack of flexible synthesis platforms, which are needed to fine tune the material's structure and performance. DRX powders are typically prepared using solid-state methods, which utilize ball milling to mix inorganic precursors followed by high-temperature reactions for an appreciable amount of time (e.g., 12 hours at 1000° C. or greater than 9 hours at greater than or equal to 900° C.). These methods are difficult to scale and provide little control over the particle morphology. For oxyfluoride compositions, this lack of control is compounded by uncertainty in the product's stoichiometry due to LiF evaporation at high temperature and/or the presence residual amorphous LiF in the final product, which cannot be detected using standard scattering tools. Furthermore, preparing Mn-rich compositions (Li₁₊ₓMn_{y}Ti_{1-x-y}O_{2-z}F_{z} wherein y≥0.5) is challenging due to the high energy of Mn—F bonds compared to Li—F and Ti—F bonds. For example, difficulty has been shown in simultaneously incorporating Mn³⁺ and F⁻ into a DRX lattice when using Li₃TiO₃F and MnO precursors. Considering these challenges, alternative methods have been explored to produce DRX cathodes including mechanochemical, sol-gel, molten salt, and microwave synthesis routes. However, a need continues to exist for suitable, scalable methods of synthesizing DRX cathode materials for use in applications such as Li-ion batteries.

### SUMMARY OF THE INVENTION

A method of making a disordered rock salt cathode material for lithium-ion batteries is provided. The method includes performing combustion synthesis with an aqueous solution of metal-containing compounds to obtain a disordered rock salt (DRX) oxide or a disordered rock salt (DRX) oxyfluoride.

In specific embodiments, the method includes a two-stage process including a first stage followed by a second stage. The first stage includes the performing of combustion synthesis to obtain a metal oxide precursor. The second stage includes one or more of lithiating, fluorinating, and annealing the metal oxide precursor to obtain the disordered rock salt (DRX) oxide or the disordered rock salt (DRX) oxyfluoride.

In particular embodiments, the step of performing combustion synthesis in the first stage includes preparing a first mixture that is an aqueous solution of metal-containing compounds, adding a fuel to the first mixture to obtain a second mixture, and heating the second mixture to at least an auto-ignition temperature of the second mixture.

In certain embodiments, the metal-containing compounds include water-soluble metal compounds.

In certain embodiments, the metal-containing compounds include a metal nitrate.

In certain embodiments, the metal-containing compounds include one or both of: i) a lithium-containing compound; and ii) one or more transition metal-containing compound.

In certain embodiments, the metal-containing compounds include a lithium-containing compound, a manganese-containing compound, and a titanium-containing compound.

In specific embodiments, the obtained disordered rock salt (DRX) has a chemical composition according to the chemical formula Li₁₊ₓMn_{y}TM_{1-x-y}O_{2-z}F_{z} wherein 0≤x≤0.3, 0.4≤y≤1, 0≤z≤0.3, and TM is one or more transition metals selected from a group of Ti, Zr, Mo, Nb, and V.

In certain embodiments, the fuel is glycine, sucrose, malic acid, citric acid, cellulose, ethylene glycol, urea, carbohydrazide, or a combination thereof.

In particular embodiments, prior to the second stage, the metal oxide precursor is heat treated in air at a temperature in a range of from 100 to 300° C. for a time period in a range of from 0.5 to 4 hours.

In particular embodiments, the step of fluorinating the metal oxide precursor in the second stage includes combining the metal oxide precursor with lithium fluoride to obtain a third mixture, and heating the third mixture up to a predetermined temperature.

In certain embodiments, the predetermined temperature is in a range of from 700 to 1,100° C.

In certain embodiments, combining the metal oxide precursor with lithium fluoride includes grinding the metal oxide precursor and lithium fluoride.

In particular embodiments, the step of lithiating the metal oxide precursor in the second stage includes combining the metal oxide precursor with a lithium-containing agent to obtain a fourth mixture, and heating the fourth mixture up to a predetermined temperature.

In particular embodiments, the step of annealing the metal oxide precursor in the second stage includes heating the metal oxide precursor up to a predetermined temperature.

In specific embodiments, the obtained DRX oxyfluoride is a Mn/Ti-based DRX oxyfluoride.

In particular embodiments, the Mn/Ti-based DRX oxyfluoride has a nominal composition of: i) Li_{1.25}Mn_{0.5}Ti_{0.3}O_{1.95}F_{0.05}; ii) Li_{1.35}Mn_{0.7}Ti_{0.1}O_{1.85}F_{0.15}; or iii) Li_{1.1}Mn_{0.8}Ti_{0.1}O_{1.9}F_{0.1}.

A lithium-ion battery cathode including a disordered rock salt cathode material made by the method is also provided.

A lithium-ion battery including the lithium-ion battery cathode is further provided.

These and other features of the invention will be more fully understood and appreciated by reference to the description of the embodiments and the drawings.

### BRIEF DESCRIPTION OF THE DRAWINGS

FIG. 1 is a flowchart of a method of making a disordered rock salt cathode material in accordance with embodiments of the disclosure;

FIG. 2 is a graph of voltage profiles illustrating galvanostatic cycling performance of a Li_{1.35}Mn_{0.7}Ti_{0.1}O_{1.85}F_{0.15} DRX cathode made by grinding an oxide precursor with LiF in air in accordance with embodiments of the disclosure;

FIG. 3 is a graph of charge/discharge capacities illustrating galvanostatic cycling performance of the Li_{1.35}Mn_{0.7}Ti_{0.1}O_{1.85}F_{0.15} DRX cathode of FIG. 2;

FIG. 4 is a graph of a voltage profile illustrating a first galvanostatic cycle of Li_{1.35}Mn_{0.7}Ti_{0.1}O_{1.85}F_{0.15} DRX cathodes made in accordance with embodiments of the disclosure, either by grinding an oxide precursor with LiF in air (“ambient grinding”) or under a dry argon (Ar) atmosphere (“dry grinding”);

FIG. 5 is a graph of voltage profiles illustrating galvanostatic cycling performance of the Li_{1.35}Mn_{0.7}Ti_{0.1}O_{1.85}F_{0.15} DRX cathodes of FIG. 4;

FIG. 6 is a graph of discharge capacities illustrating galvanostatic cycling performance of the Li_{1.35}Mn_{0.7}Ti_{0.1}O_{1.85}F_{0.15} DRX cathodes of FIG. 4; and

FIG. 7 is a graph of charge/discharge capacities illustrating galvanostatic cycling performance of the Li_{1.35}Mn_{0.7}Ti_{0.1}O_{1.85}F_{0.15} DRX cathodes of FIG. 4.

### DETAILED DESCRIPTION OF THE CURRENT EMBODIMENTS

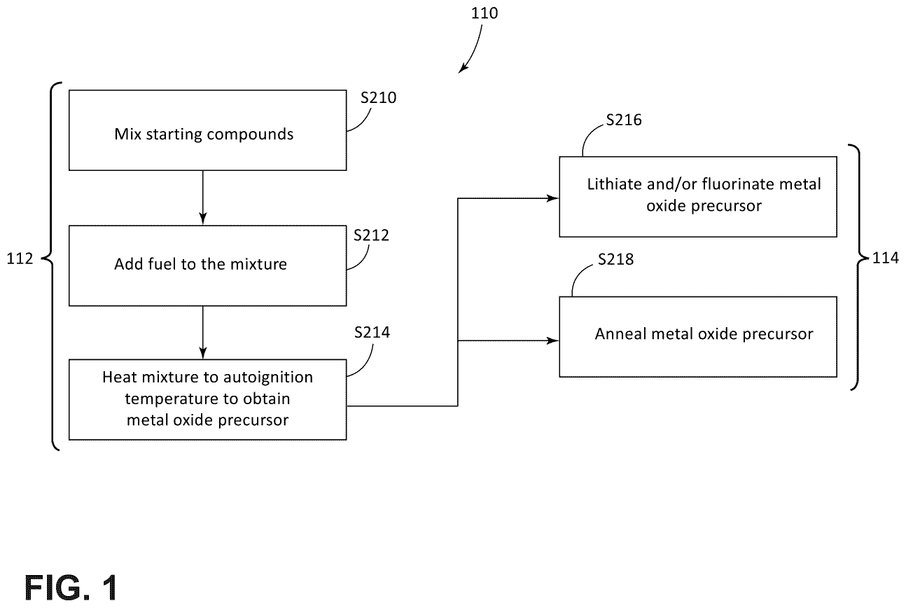

As discussed herein, the current embodiments relate to a method of making a disordered rock salt (DRX) cathode material. The method includes performing combustion synthesis with an aqueous solution of metal-containing compounds. As generally illustrated in FIG. 1, in various embodiments the method 110 may include a two-stage process in which the first stage 112 includes performing combustion synthesis to obtain a metal oxide precursor and the second stage 114 includes further treatment of the metal oxide precursor such as lithiating, fluorinating, and/or annealing the metal oxide precursor to obtain a disordered rock salt oxide or oxyfluoride. Alternatively, the method may be performed in a single stage in which the desired disordered rock salt product is obtained in one step from combustion synthesis. The method 110 provides for DRX material formation at lower temperatures and/or in shorter times compared to conventional solid-state formation methods. Also, the method 110 is easily scalable, in contrast to conventional solid-state formation methods which are difficult to scale. Each step is separately discussed below.

The method 110 first includes combustion synthesis to obtain a metal oxide precursor. At step S210, the combustion synthesis stage 112 of the method 100 includes preparing a first mixture that is an aqueous solution of metal-containing compounds. The metal-containing compounds are water-soluble compounds that may be ionic compounds in the form of a metal cation and an anion such as a nitrate or may be a coordination complex including a metal or metal ion and one or more ligands. In various embodiments, the metal-containing compounds include at least one metal nitrate which also functions as an oxidizing agent. In various embodiments, the metal-containing compounds include a lithium-containing compound and/or one or more transition metal-containing compound. In certain embodiments, the metal-containing compounds include a lithium-containing compound, a manganese-containing compound, and at least one transition metal-containing compound that contains a transition metal. The transition metals may include one or more of titanium (Ti), zirconium (Zr), molybdenum (Mo), niobium (Nb), and vanadium (V). The metal-containing compounds may be in the form of metal nitrates.

At step S212, the combustion synthesis stage 112 further includes adding a fuel to the first mixture to obtain a second mixture that is a mixture of the aqueous solution of metal-containing compounds and the fuel. In various embodiments, the fuel is glycine. In other embodiments, the fuel may be sucrose, malic acid, citric acid, cellulose, ethylene glycol, urea, carbohydrazide, or a combination of any two or more of the fuels. In certain embodiments, the fuel is glycine and the metal-containing compounds include at least one metal nitrate.

At step S214, the combustion synthesis stage 112 further includes heating the second mixture to at least an autoignition temperature of the second mixture to cause the water in the second mixture to evaporate and the second mixture to subsequently combust. By definition, the autoignition temperature is the lowest temperature at which a substance spontaneously ignites without an external ignition source such as a spark or flame. In some embodiments, the second mixture is heated to a temperature in range of from approximately 300 to 500° C., optionally between 30° and 450° C., optionally between 30° and 400° C., optionally between 35° and 450° C., optionally between 35° and 400° C., optionally between 30° and 350° C., optionally between 40° and 500° C. The heating may be performed by introducing a heat source to the second mixture to raise the temperature of the second mixture to at least the autoignition temperature. Alternatively, the heating may be performed by subjecting the second mixture to an environment that is at temperature that is at or above the autoignition temperature of the second mixture, such as by placing the second mixture into an oven or furnace that is at or above the autoignition temperature. It should also be understood that once the second mixture auto-ignites and the reaction begins, the heat of the reaction may increase the temperature of the reacting second mixture well above the autoignition temperature. Heating and combusting the second mixture results in the rapid formation of a metal oxide precursor, and once combustion begins, the reaction may be complete in a time period in the order of minutes or tens of minutes. The combustion synthesis is therefore performed at a modest reaction temperature in order to initiate the self-propagating exothermic reaction. To ensure that the second mixture is fully reacted before proceeding to the second stage and/or to assure that the second mixture is dry, a thermal treatment may be performed by heat treating the metal oxide precursor at a temperature in a range of from approximately 100 to 300° C. for a time period in a range of from 0.5 to 4 hours. This heat treatment may be performed at atmospheric conditions or alternatively under a vacuum.

The method further includes treatment of the metal oxide precursor in the second stage 114 to obtain the desired disordered rock salt (DRX) oxide or oxyfluoride. At step S216, in various embodiments, the second stage 114 of the method 100 may include lithiating and/or fluorinating the metal oxide precursor. In some embodiments, the metal oxide precursor is fluorinated by combining the metal oxide precursor with lithium fluoride (LiF) to obtain a third mixture. Combining the metal oxide precursor and lithium fluoride may include grinding together the metal oxide precursor and lithium fluoride. The grinding may be performed under air or alternatively under argon gas. The third mixture including the metal oxide precursor and lithium fluoride is then heated up to a predetermined temperature. The predetermined temperature may be in a range of from approximately 700 to 1,100° C., optionally in a range of from 700 to 1000° C., optionally in a range of from 800 to 1000° C., optionally in a range of from 700 to 800° C., optionally in a range of from 1000 to 1,100° C., optionally 900 to 1,000° C. The heating may be performed at a ramp rate of approximately 10° C. min⁻¹, optionally in a range of from approximately 5 to 15° C. min⁻¹. Alternatively, the heating may be performed by placing the third mixture into an oven or furnace that is at the predetermined temperature. Once the predetermined temperature is reached, the predetermined temperature may be maintained for a dwell time in a range of from 0 minutes (no dwell) to approximately 4 hours, optionally in a range of from approximately 10 minutes to 4 hours, optionally in a range of from 30 minutes to 4 hours, optionally in a range of from 1 hour to 4 hours. After heating, cooling is performed at a rate of between approximately 5 and 120° C. min⁻¹, optionally in a range of from 5 and 60° C. min⁻¹, optionally in a range of from 5 and 30° C. min⁻¹, optionally in a range of from 5 and 20° C. min⁻¹, optionally in a range of from 60 and 120° C. min⁻¹, optionally in a range of from 90 and 120° C. min⁻¹, optionally in a range of from 20 and 90° C. min⁻¹, optionally in a range of from 20 and 60° C. min⁻¹. Alternatively, a thermal quenching process may be performed by removing the third mixture from the furnace that is at the predetermined temperature. Quenching may, for example, provide an advantage of smaller particle size. Alternatively, or in addition, in other embodiments the metal oxide precursor is lithiated by combining the metal oxide precursor with a lithium-containing agent such as lithium carbonate (Li₂CO₃), lithium oxide (Li₂O), or lithium hydroxide (LiOH) to obtain a fourth mixture. Combining the metal oxide precursor and the lithium-containing agent may include grinding together the metal oxide precursor and the lithium-containing agent. The grinding may be performed under air or alternatively under argon gas. The fourth mixture including the metal oxide precursor and the lithium-containing agent is then heated up to a predetermined temperature. The predetermined temperature may be in a range of from 700 to 1,100° C., optionally in a range of from 700 to 1000° C., optionally in a range of from 800 to 1000° C., optionally in a range of from 700 to 800° C., optionally in a range of from 1000 to 1,100° C., optionally 900 to 1,000° C. The heating may be performed at a ramp rate of approximately 10° C. min⁻¹, optionally in a range of from approximately 5 to 15° C. min⁻¹ Alternatively, the heating may be performed by placing the third mixture into an oven or furnace that is at the predetermined temperature. Once the predetermined temperature is reached, the predetermined temperature may be maintained for a dwell time in a range of from 0 minutes (no dwell) to approximately 4 hours, optionally in a range of from approximately 10 minutes to 4 hours, optionally in a range of from 30 minutes to 4 hours, optionally in a range of from 1 hour to 4 hours. After heating, cooling is performed at a rate of between approximately 5 and 120° C. min⁻¹, optionally in a range of from 5 and 60° C. min⁻¹, optionally in a range of from 5 and 30° C. min⁻¹, optionally in a range of from 5 and 20° C. min⁻¹, optionally in a range of from 60 and 120° C. min⁻¹, optionally in a range of from 90 and 120° C. min⁻¹, optionally in a range of from 20 and 90° C. min⁻¹, optionally in a range of from 20 and 60° C. min⁻¹. Alternatively, a thermal quenching process may be performed by removing the third mixture from the furnace that is at the predetermined temperature.

At step S218, in other embodiments, the second stage 114 of the method 100 may include annealing the metal oxide precursor by heating the metal oxide precursor to a predetermined temperature and maintaining the temperature for a period of time. The predetermined temperature may be in a range of from 700 to 1,100° C., optionally in a range of from 700 to 1000° C., optionally in a range of from 800 to 1000° C., optionally in a range of from 700 to 800° C., optionally in a range of from 1000 to 1,100° C., optionally 900 to 1,000° C. The heating may be performed at a ramp rate of approximately 10° C. min⁻¹, optionally in a range of from approximately 5 to 15° C. min⁻¹. Alternatively, the heating may be performed by placing the third mixture into an oven or furnace that is at the predetermined temperature. Once the predetermined temperature is reached, the predetermined temperature may be maintained for a dwell time in a range of from 0 minutes (no dwell) to approximately 4 hours, optionally in a range of from approximately 10 minutes to 4 hours, optionally in a range of from 30 minutes to 4 hours, optionally in a range of from 1 hour to 4 hours. After heating, cooling is performed at a rate of between approximately 5 and 120° C. min⁻¹, optionally in a range of from 5 and 60° C. min⁻¹, optionally in a range of from 5 and 30° C. min⁻¹, optionally in a range of from 5 and 20° C. min⁻¹, optionally in a range of from 60 and 120° C. min⁻¹, optionally in a range of from 90 and 120° C. min⁻¹, optionally in a range of from 20 and 90° C. min⁻¹, optionally in a range of from 20 and 60° C. min⁻¹. Alternatively, a thermal quenching process may be performed by removing the third mixture from the furnace that is at the predetermined temperature.

In yet other embodiments, the method may include both lithiating and/or fluorinating the metal oxide precursor as well as annealing the metal oxide precursor as described above.

The obtained disordered rock salt (DRX) oxide or oxyfluoride may be in the form of a nanocrystalline oxide powder and may have a chemical composition according to the following Formula (I):

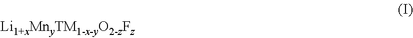

wherein 0≤x≤0.3, 0.4≤y≤1, 0≤z≤0.3, and TM is one or more transition metals selected from a group of Ti, Zr, Mo, Nb, and V. In certain embodiments, the obtained DRX oxyfluoride is an Mn/Ti-based DRX oxyfluoride which may have, for example, a nominal composition of Li_{1.25}Mn_{0.5}Ti_{0.3}O_{1.95}F_{0.05}, Li_{1.35}Mn_{0.7}Ti_{0.1}O_{1.85}F_{0.15}, or Li_{1.1}Mn_{0.8}Ti_{0.1}O_{1.9}F_{0.1}. In certain embodiments, the molar ratio of Mn/Ti is in a range of from between approximately 5/3 and 7/1.

### EXAMPLES

The present method is further described in connection with the following laboratory examples, which are intended to be non-limiting.

Oxide precursors with the nominal formulae Li_{1.2}Mn_{0.5}Ti_{0.3}O_{1.95} and Li_{1.2}Mn_{0.7}Ti_{0.1}O_{1.85} were synthesized via combustion reactions. Stoichiometric amounts of Mn nitrate, Li nitrate, and TYZOR® titanate from ChemPoint were mixed to form a single solution. Glycine was dissolved in the precursor solution using a stoichiometric glycine-nitrate ratio, which was calculated assuming that: (i) the only gaseous by-products are H₂O, CO₂, and N₂ and (ii) all nitrates and glycine are consumed in the reaction. The solution was heated on a hotplate to 350° C. in air, initially producing a white foam and releasing some NOx species before combusting to form a black solid. The solid was ground with a ceramic mortar and pestle and heated to 300° C. in a muffle furnace in air for 2 hours (at heating and cooling rates of +10° C. min⁻¹), after which the sample was ground again and stored in a desiccator. Due to the release of NOx species, the combustion synthesis should be performed inside a fume hood. Combustion synthesis also produces nanocrystalline samples, which can be present as nanoparticles. Therefore, the fume hood should also be suitable for nanomaterials.

Subsequently, annealed oxide powders with targeted compositions of Li_{1.2}Mn_{0.5}Ti_{0.3}O_{1.95} and Li_{1.2}Mn_{0.7}Ti_{0.1}O_{1.85} were prepared by heating the precursors obtained by combustion synthesis to 1000° C. under flowing argon (Ar) gas for 4 and 1 hours, respectively (at heating/cooling rates of +5° C. min⁻¹). A third oxide powder with the nominal composition Li_{1.25}Mn_{0.5} Ti_{0.3}O_{1.975} was synthesized by reacting the precursor with Li₂O (obtained from Thermo Fisher Scientific, 99.5%) based on the following reaction:

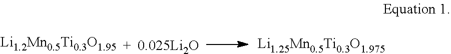

DRX oxyfluorides with nominal compositions of Li_{1.25}Mn_{0.5}Ti_{0.3}O_{1.95}F_{0.05} and Li_{1.35}Mn_{0.7}Ti_{0.1}O_{1.85}F_{0.15} were synthesized by grinding the oxide precursors with stoichiometric amounts of LiF (obtained from Alfa Aesar, 99.8%) and heating to 800-1000° C. under flowing Ar for 1 hour (at heating/cooling rates of +5° C. min⁻¹). Initially, the precursors were ground with LiF in air. However, as the precursors are hygroscopic, a second set of syntheses was performed by grinding the precursors (dried at 90° C. under vacuum for 24 hours) with LiF in an Ar-filled glove box with low H₂O content (<10 ppm). The compositions of select samples were determined using ICP-OES and F-ISE. A summary of the syntheses is shown in Table 1 below.

TABLE 1
Summary of the reaction routes with the oxide
precursors obtained by combustion synthesis*

| | Reaction | Product |
|---|---|---|
| Reactants | Conditions | Composition |
| Li_{1.2}Mn_{0.5}Ti_{0.3}O_{1.95} | 1000° C., | 47.6(8)% DRX |
| | 4 h | 45.9(8)% m-Rock Salt |
| | | 6.5(5)% LiMn₂O₄ |
| Li_{1.2}Mn_{0.5}Ti_{0.3}O_{1.95} + | 1000° C., | 53.1(7)% DRX |
| 0.025Li₂O | 1 h | 42.6(7)% m-Rock Salt |
| (Ground in Air) | | 4.3(3)% LiMn₂O₄ |
| Li_{1.2}Mn_{0.5}Ti_{0.3}O_{1.95} + | 1000° C., | 94.1(2)% DRX |
| 0.05LiF | 1 h | 3.25(18)% m-Rock Salt |
| (Ground in Air) | | 2.70(13)% LiMn₂O₄ |
| Li_{1.2}Mn_{0.5}Ti_{0.3}O_{1.95} + | 800° C., | 86.4(3)% DRX |
| 0.05LiF | 1 h | 12.1(6)% m-Rock Salt |
| (Ground in Air) | | 1.56(16)% o-Rock Salt |
| Li_{1.2}Mn_{0.5}Ti_{0.3}O_{1.95} + | 1000° C., | 69.3(4)% DRX |
| 0.05LiF | 4 h | 30.7(4)% m-Rock Salt |
| (Ground in Air) | | |
| Li_{1.2}Mn_{0.5}Ti_{0.3}O_{1.95} + | 800° C., | 92.0(2)% DRX |
| 0.05LiF | 1 h | 8.0(2)% m-Rock Salt |
| (Ground under Ar) | | |
| Li_{1.2}Mn_{0.7}Ti_{0.1}O_{1.85} | 1000° C., | 0.8(2)% LiMn₂O₄ |
| | 1 h | 66.6(5)% m-Rock Salt |
| | | 28.0(5)% o-Rock Salt |
| | | 4.6(4)% Li₂MnO₂ |
| Li_{1.2}Mn_{0.7}Ti_{0.1}O_{1.85} + | 1000° C., | 81.5(8)% DRX |
| 0.15LiF | 1 h | 11.8(3)% m-Rock Salt |
| (Ground in Air) | | 7.2(9)% LiF |
| Li_{1.2}Mn_{0.7}Ti_{0.1}O_{1.85} + | 1000° C., | 78(4)% DRX |
| 0.15LiF | 1 h | 8.1(5)% m-Rock Salt |
| (Ground under Ar) | | 14(4)% LiF |
| Li_{1.2}Mn_{0.7}Ti_{0.1}O_{1.85} + | 800° C., | 12.6(7)% DRX |
| 0.15LiF | 1 h | 33.3(11)% m-Rock Salt |
| (Ground under Ar) | | 9.5(4)% o-Rock Salt |
| | | 11.6(6)% LiMn₂O₄ |
| | | 33(2)% LiF |

*m-Rock Salt and o-Rock Salt refer to impurity phases with a monoclinic and orthorhombic structure, respectively.

To confirm the identity of an impurity peak visible in the 19F ssNMR spectrum for Li_{1.25}Mn_{0.5}Ti_{0.3}O_{1.95}F_{0.05}, Li₃TiO₃F was synthesized via a solid-state route. Stoichiometric amounts of Li₂CO₃ (obtained from Sigma, 99.99%), TiO₂ (obtained from Sigma, 99.99%), and LiF (obtained from Sigma, 99.99%) were intimately mixed by grinding with a mortar and pestle, then pressed into a pellet with a 10 mm diameter. The pellet was calcined at 800° C. for 24 hours. The sample was quenched by removing the pellet from the furnace at 800° C. and subsequently hand-ground for characterization.

Ex-situ XRD was performed using a Rigaku SmartLab with a HyPix-3000 detector set in horizontal mode measuring with Bragg-Brentano geometry and a Mo radiation source consisting of 2:1 K_{α1}:K_{α2} (λ₁=0.70930 Å; λ₂=0.71359 Å). Data were collected with a θ/2θ range of 5-65° and a scan time of 1.5° min⁻¹. Additional data were collected using a Cu radiation source consisting of 2:1 K_{α1}:K_{α2} (λ₁=1.54056 Å; λ₂=1.54439 Å) with a θ/2θ range of 10-90° and a scan time of 1.5° min⁻¹. The dried Li_{1.2}Mn_{0.5}Ti_{0.3}O_{1.95} and Li_{1.2}Mn_{0.7}Ti_{0.1}O_{1.85} precursors were measured using an air-tight sample holder which was loaded inside an Ar-filled glove box. All other powders were loaded in air onto glass sample holders. Ex-situ XRD data for Li₃TiO₃F were collected using a Panalytical Empyrean with a Cu radiation source with a mixture of 2:1 K_{α1}:K_{α2} with a θ/2θ range of 10-90° and a rate of 0.2° per 0.01° min.

In-situ XRD data were collected using a Panalytical Xpert with a Cu radiation source consisting of 2:1 K_{α1}:K_{α2} with a θ/2θ range of 10-90° and a scan time of 1.5° min⁻¹ at each temperature. For these measurements, Li_{1.2}Mn_{0.5}Ti_{0.3}O_{1.95} was ground with LiF in an Ar-filled glove box, and the sample was heated under flowing Ar using an Anton Paar XKR-900 furnace. The powder was loaded onto the sample holder in air. Data were collected at 27° C., and incrementally every 100° C. from 100-800° C. at a ramp rate of 10° C. min⁻¹. The sample was left to equilibrate for 3 minutes before each measurement.

Rietveld refinements were performed against ex-situ and in-situ XRD data using TOPAS-Academic v7 to determine phase composition. Cell parameters for each phase were refined with symmetry constraints. A single isotropic atomic displacement parameter was used for each phase. The background was modelled using a 12-fold Chebyshev polynomial, and peak shapes were modelled using a Thompson-Hastings-Cox pseudo-Voigt function. The DRX phase was modelled using the compositions Li_{1.2}Mn_{0.4}Ti_{0.4}O₂ and Li_{1.1}Mn_{0.8}Ti_{0.1}O₂ for the low-Mn and Mn-rich phases, respectively. Atomic occupancies were not refined. For Li_{1.25}Mn_{0.5}Ti_{0.3}O_{1.95}F_{0.05}, Li₂TiO₃ (space group: (2/c) was used to model monoclinic rock salt phases while for Li_{1.35}Mn_{0.7}Ti_{0.1}O_{1.85}F_{0.15}, Li₂MnO₃ (space group: C2/m) was used instead. LiMnO₂ (space group: Pmmm) was used to model orthorhombic rock salt phases for both compositions. For in-situ experiments, 4 to 5 secondary phases were included to obtain weight percentages at each temperature. For the precursors, a 4-fold spherical harmonic function was applied to model preferred orientation observed in LiNO₃.

As-synthesized Li_{1.2}Mn_{0.5}Ti_{0.3}O_{1.95}F_{0.05} and Li_{1.2}Mn_{0.7}Ti_{0.1}O_{1.85}F_{0.15} samples were analyzed using ⁷Li and ¹⁹F ssNMR spectroscopy to evaluate the distributions of Li and F local environments. ⁷Li and ¹⁹F ssNMR spectra were acquired using a wide bore Bruker BioSpin spectrometer charged to 2.35 T (100 MHz for 1H) and equipped with a DMX 500 MHz console and a custom-made 1.3 mm, single channel broadband magic-angle spinning (MAS) probe tuned to either ⁷Li (38.9 MHz) or ¹⁹F (94.1 MHz). Spectra were obtained using a rotor-synchronized spin-echo sequence (90°−τ_{R}−180°−τ_{R}) using a 90° radio frequency pulse of 0.45 μs for ⁷Li and of 0.3 μs for ¹⁹F. ⁷Li chemical shifts were externally referenced against a 1 M aqueous LiCl solution (δᵢₛₒ=0 ppm). ¹⁹F chemical shifts were referenced against a 1 M aqueous NaF (¹⁹F δᵢₛₒ=−118.14 ppm) solution. A long recycle delay of 20 seconds was used for all ⁷Li ssNMR acquisitions, to ensure that all ⁷Li spins in the sample re-equilibrated between scans. For ¹⁹F ssNMR, a first acquisition was conducted using a short recycle delay of 20 milliseconds to maximize the signal from paramagnetic F environments in the DRX structure, and a second acquisition was conducted using a long recycle delay of 20 seconds to obtain a quantitative measurement of the diamagnetic F species within each sample. Samples were loaded into NMR rotors in an Ar-filled glovebox, and the rotors were spun at 60 kHz MAS using dry nitrogen during data acquisition. The NMR data was processed using the Bruker TopSpin 3.6.0 software.

SEM was performed using a Zeiss MERLIN electron microscope operating at an accelerating voltage of 1.0 kV. Prior to measurements, powder samples were ground with a mortar and pestle and adhered to carbon tape.

The performance of DRX oxyfluoride materials was evaluated in composite slurry-cast cathodes. A DRX: graphite (MSE, TIMCAL KS-6) mixture (78:22 w:w) was milled in a SPEX® 8000M using a stainless steel jar with 5 mm stainless steel media (mass ratio of 10:1 media: powder) for 1 hour. The milled mixture was blended with N-methyl-2-pyrrolidone (NMP obtained from Sigma, 99.5%) and polyvinylidene fluoride (PVDF obtained from Kynar) binder (10 wt. % in NMP) in a polypropylene vial on a Turbula T2F mixer for 1 hour. The slurry was cast onto a C-coated aluminum current collector using a doctor blade (wet gap 200 μm). The electrode laminates were dried in air on a hot plate at 100° C. for 2 hours. Cathode disks ( 7/16″ diameter) were punched and dried under vacuum at 90° C. overnight and transferred to an Ar-filled glove box. The final electrodes contained DRX/graphite/PVDF in a 70/20/10 weight ratio and had areal loadings of approximately 2 mgDRY cm 2. Flooded R2032 cells containing the DRX cathode, Celgard 2325 separator, 1.2 M LiPF₆ electrolyte in 3:7 ethylene carbonate:ethyl methyl carbonate (w: w, obtained from SoulBrain MI), and Li metal auxiliary/reference electrode (0.75 mm thick disc) were prepared in the glovebox. Electrochemical performance was evaluated on a Maccor 4000 battery cycler by polarizing the cathodes between 2.0-4.8 V vs. Li/Lit at specific currents of 10 mA g⁻¹ for the first 5 cycles followed by 20 mA g⁻¹ for subsequent cycles.

Heating the Li_{1.2}Mn_{0.5}Ti_{0.3}O_{1.95} precursor to 1000° C. under Ar for 4 hours yielded a powder with only 47.6 (8) % DRX and a large amount of secondary phases including a monoclinic rock salt (45.9(8)%) and LiMn₂O₄ spinel (6.5(5)%) as observed in the Rietveld plots. It should be noted that Mn³⁺, Mn⁴⁺ and Ti⁴⁺ cannot be distinguished with XRD due to their similar form factors. As such, the monoclinic rock salt could be present as Li₂TiO₃, Li₂MnO₃ or Li₂Ti₁₋ₓMnₓO₃. To mitigate possible Li loss during annealing, a second synthesis attempt involved grinding the precursor with Li₂O prior to heating. The resulting product contained similar amounts of undesired monoclinic rock salt (42.6(7)%) and spinel (4.3(3)%) phases.

Additional reactions were performed to assess the effects of F-substitution on the final product's structure and phase purity. Here, LiF was mixed with the Li_{1.2}Mn_{0.5}Ti_{0.3}O_{1.95} precursor prior to the high-temperature reaction described by Equation 2:

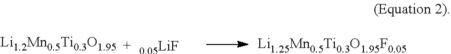

Heating this mixture to 1000° C. for 1 hour yielded a product with 94.1(2)% DRX, 3.25(18)% monoclinic rock salt, and 2.70(13)% LiMn₂O₄ spinel as observed in the Rietveld plots. Comparing these results with those above demonstrated that adding LiF to the precursor greatly facilitates DRX phase formation. Similarly, heating to 800° C. for 1 hour yielded 86.4(3)% DRX, 12.1(6) monoclinic rock salt, and 1.56(16)% orthorhombic rock salt as observed in the Rietveld plots. Two possible mechanisms for the effect of LiF include: (i) LiF serving as a sintering agent and/or (ii) F-substitution in the DRX lattice altering the reaction pathway.

To further probe the reaction between the Li_{1.2}Mn_{0.5}Ti_{0.3}O_{1.95} precursor and LiF, in-situ XRD analysis was performed. The XRD data revealed that the starting precursor contains nanocrystalline Mn₂O₃ and LiMn₂O₄, with sharp Bragg reflections arising from unreacted LiNO₃. The sharp peaks disappear upon heating to 300° C. due to melting of the LiNO₃ phase. Rietveld refinements were performed for the XRD data acquired between 30° and 800° C. At 300° C., the sample was primarily LiMn₂O₄ (43.4(16)%) and Mn₂O₃ (24.6(12)%). At 500° C., the monoclinic rock salt becomes the dominant phase, accounting for 45(3)% of the sample. The DRX phase may also begin forming at this stage, as the weight percentage derived from this refinement is 30(2)%. However, it should be noted that the peaks are very broad at this temperature, resulting in significant overlap between the reflections associated with the DRX, monoclinic rock salt and LiMn₂O₄ phases. At 700° C., the DRX phase is clearly present, with a weight percentage of 38(2)%. At 800° C., the dominant phase is DRX (76.8(13)%), in good agreement with the ex-situ results.

While the XRD patterns indicated that blending the oxide precursor with LiF is critical to increase DRX phase conversion, these results did not reveal whether F-anions are successfully incorporated into the DRX lattice, as F⁻ and O²⁻ possess similar X-ray form factors. To further probe the distribution of local Li and F environments in the final product, the Li_{1.25}Mn_{0.5}Ti_{0.3}O_{1.95}F_{0.05} sample (annealed at 800° C.) was analyzed using ⁷Li and ¹⁹F solid-state nuclear magnetic resonance (ssNMR) spectroscopy. The ⁷Li ssNMR spectrum contained two major components: (i) a sharp resonance near 0 ppm arising from Li in diamagnetic environments (e.g., Li in a Ti⁴⁺-only rock salt phase and/or in amorphous impurity phases such Li₂CO₃, LiOH, or LiF) and (ii) a broad resonance spanning the range from −100 to 1000 ppm attributed to Li in the DRX phase. A shoulder at ˜320 ppm indicated the presence of an ordered paramagnetic (i.e. Mn-containing) phase, e.g. m-Li₂Mn₁₋ₓTiₓO₃. The small shoulder at ˜36 ppm could be attributed to a small amount of orthorhombic LiMnO₂, consistent with the XRD analysis. An ordered, monoclinic LiMnO₂ phase would have a ⁷Li resonance at around 130-140 ppm, which was not observed here, and therefore, this phase was not present.

¹⁹F ssNMR spectra were recorded under two conditions using either: (i) a long (20 second) inter-scan delay to obtain quantitative insights into the diamagnetic F environments, or (ii) a short (20 millisecond) delay to enhance the intensity of the fast-relaxing paramagnetic signals. Notably, ¹⁹F ssNMR underestimates the amount of F incorporated into the bulk DRX structure, as a fraction of DRX F species (those that are directly bonded to paramagnetic Mn) gives rise to signals that are too short-lived to be observed by NMR. A rough fit of the ¹⁹F NMR spectrum indicated that, while the major component centered at −100 ppm is consistent with F in the DRX phase, a secondary component centered around −200 ppm indicated the presence of a minor, F⁻-containing phase that was too broad to be attributed solely to LiF, which may be present as an amorphous phase not detected by XRD. To identify this secondary phase, a candidate rock salt phase, Li₃TiO₃F, was synthesized through a solid-state reaction. XRD and ssNMR measurements indicated this material is phase-pure with a single Li crystallographic environment resonating at 0 ppm and a single F crystallographic site resonating at about-192 ppm. Both of these chemical shifts were consistent with the impurity signals observed in the ssNMR spectra for Li_{1.25}Mn_{0.5}Ti_{0.3}O_{1.95}F_{0.05}. While the ¹⁹F resonance for Li₃TiO₃F perfectly matched that of the impurity signal, these phases may contain different F content. Therefore, this impurity is more appropriately described by the general formula Li_{(2+δ)/3}Ti_{(1-δ)/3}O_{1-δ}F_{δ}, where δ>0. As Li_{(2+δ)/3}Ti_{(1-δ)/3}O_{1-δ}F_{δ} also adopts the Fm-3m rock salt structure with similar cell parameters to the DRX phase, its presence was not detected by XRD patterns.

The ssNMR and XRD findings illustrated the importance of using complementary techniques to evaluate phase composition of DRX oxyfluorides. Collectively, the results indicated that Li_{1.25}Mn_{0.5}Ti_{0.3}O_{1.95}F_{0.05} contains a majority DRX phase along with secondary phases including ordered diamagnetic Li_{(2+δ)/3}Ti_{(1-δ)/3}O_{1-δ}F_{δ} (¹⁹F NMR signal at −193 ppm), paramagnetic Mn-containing (e.g. Li₂Mn₁₋ₓTiₓO₃) rock salt phases (⁷Li NMR signal at ˜320 ppm), and a small amount of orthorhombic LiMnO₂ (⁷Li signal at ˜36 ppm). The presence of trace, amorphous impurities, such as Li₂CO₃, LiOH, or LiF could not be ruled out.

Additional characterization including SEM and ICP-OES/F-ISE were performed to assess the final product's morphology and overall stoichiometry, respectively. The SEM images showed that the Li_{1.2}Mn_{0.5}Ti_{0.3}O_{1.95} (heated to 1000° C. for 4 hours) and Li_{1.25}Mn_{0.5}Ti_{0.3}O_{1.95}F_{0.05} (heated to 1000° C. for 1 hour) samples contained micron-sized primary particles which form large agglomerates (>10 μm). Interestingly, the oxyfluoride sample contained fused grains which may be the result of liquid-phase sintering enabled by a liquid flux (e.g., LiF, Tₘ=848° C.). Similar grain structure was also observed for the Li_{1.25}Mn_{0.5}Ti_{0.3}O_{1.95}F_{0.05} heated at 800° C., suggesting the solid-state reaction involved a eutectic containing the oxide precursor, intermediate phases, and/or LiF. The oxyfluoride powders heated for 1 hour at 800 and 1000° C. had measured compositions of Li_{1.25}Mn_{0.36}Ti_{0.41}O_{1.95}F_{0.05} and Li_{1.23}Mn_{0.36}Ti_{0.40}O_{1.95}F_{0.03}, respectively, indicating minimal Li and F losses occurred at 1000° C. Surprisingly, these samples had a higher-than-expected Mn/Ti ratio. This result was attributed to aging (i.e., partial evaporation) of the Ti-based precursor which increased the effective Ti concentration when preparing the oxide precursor.

To expand the two-step reaction sequence to synthesize Mn-rich DRX cathodes, an oxide precursor with the nominal formula Li_{1.2}Mn_{0.7}Ti_{0.1}O_{1.85} was also prepared. Heating the precursor to 1000° C. for 1 hour under Ar gas resulted in two monoclinic and orthorhombic ordered rock salt phases with no detectable DRX. On the other hand, grinding the Li_{1.2}Mn_{0.7}Ti_{0.1}O_{1.85} precursor with LiF as shown in Equation 3 below and annealing under the same conditions yielded predominantly the desired DRX phase (81.5(8)%). The precursor's drying history had negligible impact on the final product.

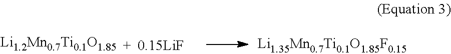

Unlike the Li_{1.25}Mn_{0.5}Ti_{0.3}O_{1.95}F_{0.05} sample, the Li_{1.35}Mn_{0.7}Ti_{0.1}O_{1.85}F_{0.15} powder contained a crystalline LiF impurity, which suggested that either: (i) the reaction did not go to completion and/or (ii) the Mn-rich DRX has a lower-than-targeted F-solubility (see Equation 3).

ssNMR was again employed to probe the distribution of Li and F local environments in the Li_{1.35}Mn_{0.7}Ti_{0.1}O_{1.85}F_{0.15} product obtained after annealing at 1000° C. The ⁷Li ssNMR spectrum contained a sharp resonance near 0 ppm attributed to Li in diamagnetic impurities (LiF and Li₂TiO₃ (monoclinic rock salt)), which were also detected by XRD. The various ⁷Li signals in the 100 to 1500 ppm region corresponded to Li species in paramagnetic environments, including: (i) a very broad resonance spanning 1000 to 0 ppm attributed to Li in the DRX phase, and (ii) sharp resonances arising from Li species in layered rock salt phases. More specifically, the 731 ppm and 1460 ppm signals were assigned to Li in the Li and transition metal layers in (monoclinic) Li₂MnO₃, and the signal at 131 ppm was assigned to Li in (monoclinic) LiMnO₂. It should be noted that monoclinic LiMnO₂ and monoclinic Li₂MnO₃ cannot be readily distinguished by XRD. Two additional resonances were observed at ˜528 ppm and 1220 ppm, which were attributed to Li in a (monoclinic) Li₂Mn₁₋ₓTiₓO₃ phase, where partial substitution of Mn by Ti reduces the ⁷Li chemical shifts compared to that of Li₂MnO₃.

The ¹⁹F ssNMR spectrum collected on Li_{1.35}Mn_{0.7}Ti_{0.1}O_{1.85}F_{0.15} showed a sharp resonance at around −204 ppm which was assigned to LiF, while the broad resonance spanning 270 to −380 ppm was attributed to F in the DRX phase. A fit of the data revealed at least 42% of the F was incorporated into the DRX structure. Overall, these results indicated the synthesis route according to the method provided herein was viable to produce DRX oxyfluorides without the need for high-energy ball milling.

The morphologies of Li_{1.2}Mn_{0.7}Ti_{0.1}O_{1.85} and Li_{1.35}Mn_{0.7}Ti_{0.1}O_{1.85}F_{0.15} were assessed using SEM. The SEM images of both samples contained micron-sized agglomerates similar to the Li_{1.2}Mn_{0.5}Ti_{0.3}O_{1.95} and Li_{1.25}Mn_{0.5}Ti_{0.3}O_{1.95}F_{0.05} SEM images discussed above. For the oxyfluoride composition, ICP-OES/F-ISE results indicated an overall sample composition of Li_{1.26}Mn_{0.72}Ti_{0.11}O_{1.85}F_{0.15} (see Table 2 below), in good agreement with the nominal composition of Li_{1.35}Mn_{0.7}Ti_{0.1}O_{1.85}F_{0.15}. The sample was slightly Li deficient (1.26 versus 1.35), which suggests that Li loss occurred either during the combustion reaction, or during the high-temperature annealing step. As such, the effect of lower annealing temperatures was also investigated. Heating Li_{1.2}Mn_{0.7}Ti_{0.1}O_{1.85} with LiF to 800° C. for 1 hour resulted in only 20.2(8)% DRX, compared to 80(5)% DRX for Li_{1.25}Mn_{0.5}Ti_{0.3}O_{1.95}F_{0.05} heated under the same conditions.

TABLE 2
Nominal and quantitative formulae of DRX oxyfluorides obtained
by the method according to embodiments of the disclosure.

| Nominal | Annealing | Quantitative |
|---|---|---|
| Formula | Conditions | Formula |
| Li_{1.25}Mn_{0.5}Ti_{0.3}O_{1.95}F_{0.05} | 1000° C. 1 h under Ar | Li_{1.23}Mn_{0.36}Ti_{0.40}O_{1.95}F_{0.03} |
| | (ramped at 5° C. min⁻¹) | |
| Li_{1.25}Mn_{0.5}Ti_{0.3}O_{1.95}F_{0.05} | 800° C. 1 h under Ar, | Li_{1.25}Mn_{0.36}Ti_{0.41}O_{1.95}F_{0.05} |
| | (ramped at 5° C. min⁻¹) | |
| Li_{1.35}Mn_{0.7}Ti_{0.1}O_{1.95}F_{0.15} | 1000° C. 1 h under Ar | Li_{1.26}Mn_{0.72}Ti_{0.11}O_{1.85}F_{0.15} |
| | (ramped at 5° C. min⁻¹) | |

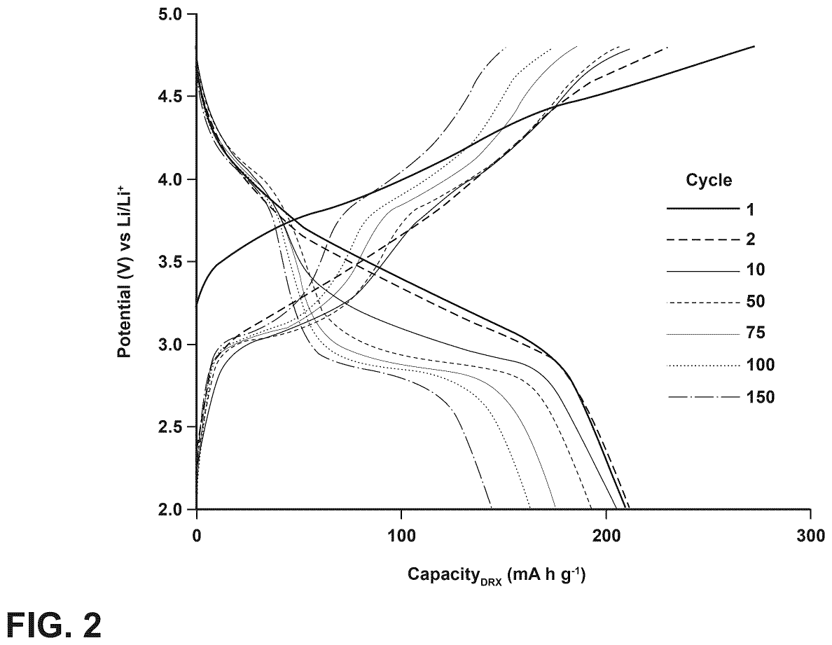

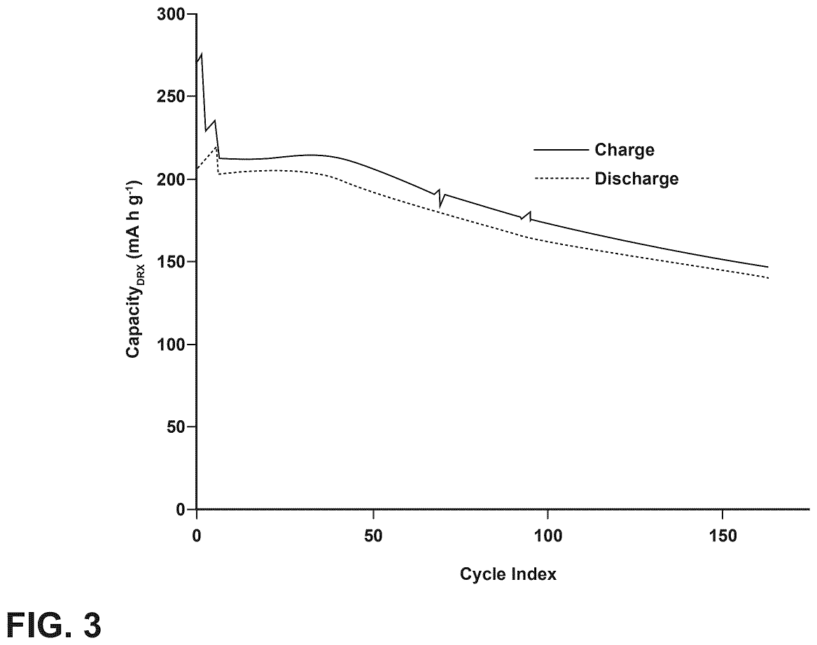

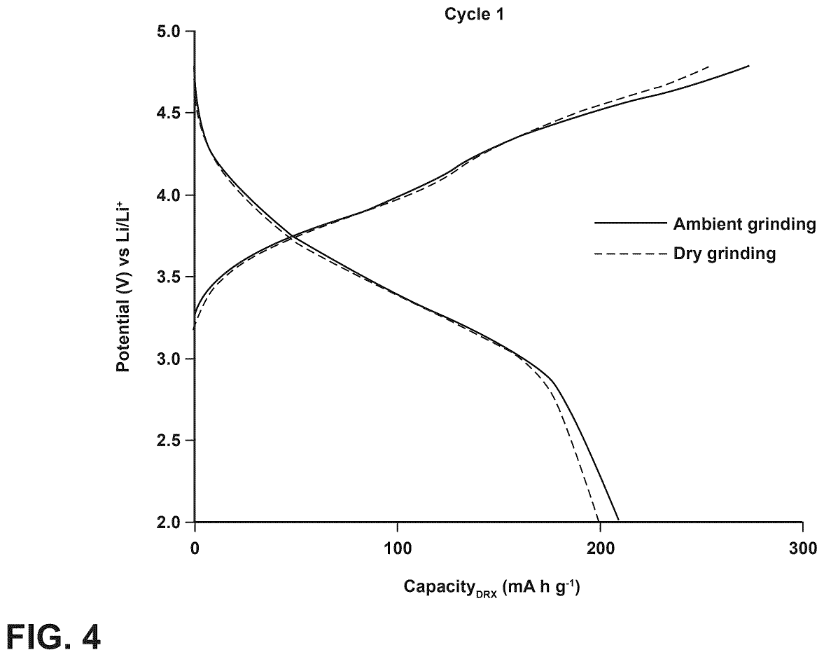

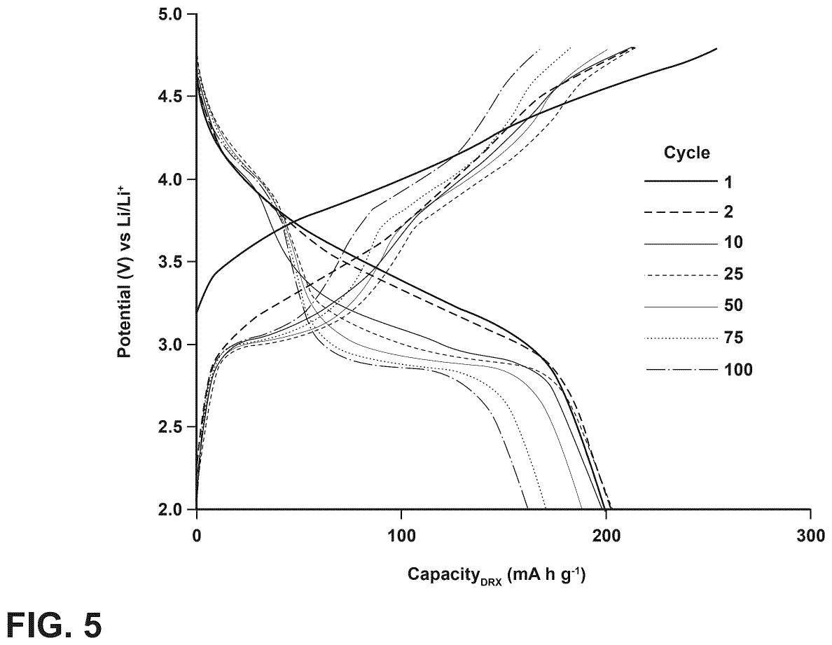

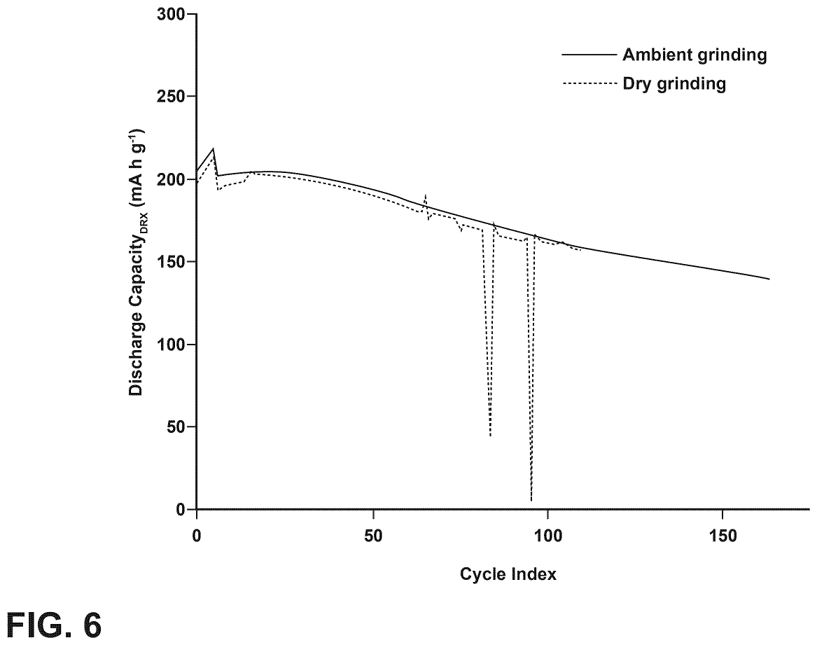

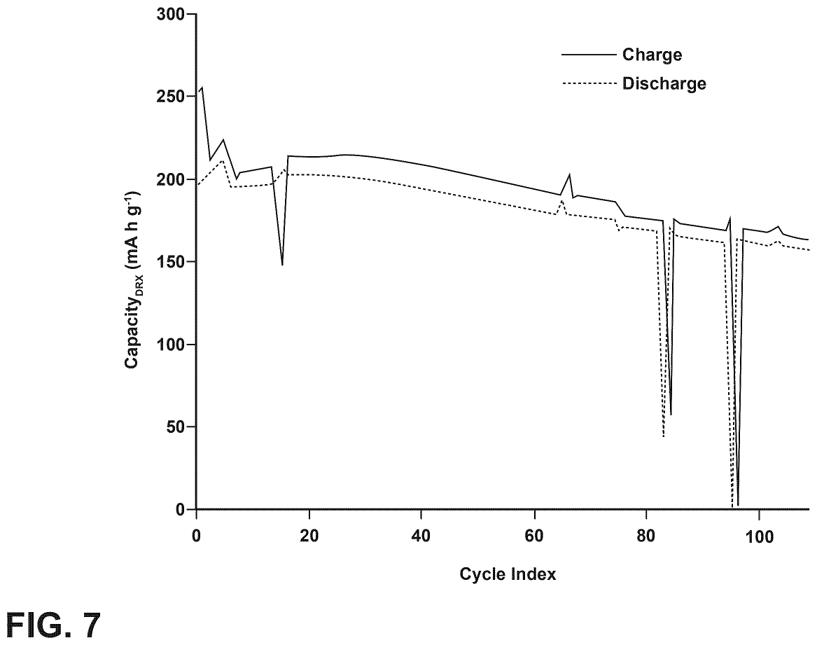

Electrochemical properties of Li_{1.35}Mn_{0.7}Ti_{0.1}O_{1.85}F_{0.15} were evaluated in Li metal half cells as shown in FIGS. 2 and 3. Composite cathodes were prepared in a two-step process where: (i) high energy milling was used to coat the active material with graphite (78:22 w:w) followed by (ii) slurry mixing and electrode casting. The dried cathode contained 70 wt. % DRX, 20 wt. % graphite, and 10 wt. % PVDF binder. Graphite was a preferable conductive additive due to formation of a robust electronically conductive network and a more stable cathode/electrolyte interface. The sample was cycled against a Li metal reference/counter electrode between 2.0 V and 4.8 V at a specific current of 10 mA g⁻¹ for the first five cycles and 20 mA g⁻¹ for subsequent cycles. FIG. 2 showed the cathode had a high initial charge capacity of approximately 270 mA h g⁻¹ and reversible capacity of approximately 215 mA h g⁻¹. These results were consistent with those obtained for materials prepared through solid-state routes and indicated charge compensation occurred through Mn and O redox centers as expected. While the initial cycles exhibited a sloping voltage profile, extended cycling yielded a plateau of approximately 3 V vs. Li/Li⁺ due to the formation of a phase comprising local spinel-ordered domains during cycling, as has been observed for other Mn-rich DRX cathodes. The material also showed good cycling stability with 65% capacity retention after 150 cycles. Notably, grinding the precursor with LiF in air versus Ar (step 2 in the synthesis route) had negligible impact on the final cathode's performance as shown in the voltage profiles and cycling capacities of FIGS. 4-7. These samples were cycled against a Li metal reference/counter electrode between 2.0 V and 4.8 V at a specific current of 10 mA g⁻¹ for the first five cycles and 20 mA g⁻¹ for subsequent cycles. The anomalous results at cycles 15, 83, 84, 95 and 96 in FIGS. 6 and 7 were due to power outages. In summary, the materials synthesized according to the methods disclosed herein exhibited reproducible performance that is competitive with similar materials prepared through conventional routes. As demonstrated, the synthesis method disclosed herein may yield 80-90% pure DRX which may achieve a capacity of ˜215 mA h g⁻¹ with moderate cycling stability (65% capacity retention over 150 cycles) in Li metal half cells.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A method of making a disordered rock salt cathode material for lithium-ion batteries, the method comprising:
performing combustion synthesis with an aqueous solution of metal-containing compounds to obtain a disordered rock salt (DRX) oxide or a disordered rock salt (DRX) oxyfluoride.

2. The method of claim 1, wherein the method comprises:
a two-stage process including a first stage followed by a second stage;
wherein the first stage includes the performing of combustion synthesis to obtain a metal oxide precursor;
wherein the second stage includes one or more of lithiating, fluorinating, and annealing the metal oxide precursor to obtain the disordered rock salt (DRX) oxide or the disordered rock salt (DRX) oxyfluoride.

3. The method of claim 2, wherein performing combustion synthesis in the first stage includes preparing a first mixture that is the aqueous solution of metal-containing compounds, adding a fuel to the first mixture to obtain a second mixture, and heating the second mixture to at least an auto-ignition temperature of the second mixture.

4. The method of claim 3, wherein the metal-containing compounds include water-soluble metal compounds.

5. The method of claim 4, wherein the metal-containing compounds include a metal nitrate.

6. The method of claim 3, wherein the metal-containing compounds include one or both of: i) a lithium-containing compound; and ii) one or more transition metal-containing compound.

7. The method of claim 3, wherein the metal-containing compounds include a lithium-containing compound, a manganese-containing compound, and a titanium-containing compound.

8. The method of claim 1, wherein the obtained disordered rock salt (DRX) has a chemical composition according to the chemical formula Li₁₊ₓMn_{y}TM_{1-x-y}O_{2-z}F_{z} wherein 0≤x≤0.3, 0.4≤y≤1, 0≤z≤0.3, and TM is one or more transition metals selected from a group of Ti, Zr, Mo, Nb, and V.

9. The method of claim 3, wherein the fuel is glycine, sucrose, malic acid, citric acid, cellulose, ethylene glycol, urea, carbohydrazide, or a combination thereof.

10. The method of claim 2, wherein prior to the second stage, the metal oxide precursor is heat treated in air at a temperature in a range of from 100 to 300° C. for a time period in a range of from 0.5 to 4 hours.

11. The method of claim 2, wherein fluorinating the metal oxide precursor in the second stage includes combining the metal oxide precursor with lithium fluoride to obtain a third mixture, and heating the third mixture up to a predetermined temperature.

12. The method of claim 11, wherein the predetermined temperature is in a range of from 700 to 1,100° C.

13. The method of claim 11, wherein combining the metal oxide precursor with lithium fluoride includes grinding the metal oxide precursor and lithium fluoride.

14. The method of claim 2, wherein lithiating the metal oxide precursor in the second stage includes combining the metal oxide precursor with a lithium-containing agent to obtain a fourth mixture, and heating the fourth mixture up to a predetermined temperature.

15. The method of claim 2, wherein annealing the metal oxide precursor in the second stage includes heating the metal oxide precursor up to a predetermined temperature.

16. The method of claim 1, wherein the obtained DRX oxyfluoride is a Mn/Ti-based DRX oxyfluoride.

17. The method of claim 16, wherein the Mn/Ti-based DRX oxyfluoride has a nominal composition of: i) Li_{1.25}Mn_{0.5}Ti_{0.3}O_{1.95}F_{0.05}; ii) Li_{1.35}Mn_{0.7}Ti_{0.1}O_{1.85}F_{0.15}; or iii) Li_{1.1}Mn_{0.8}Ti_{0.1}O_{1.9}F_{0.1}.

18. A lithium-ion battery cathode including a disordered rock salt cathode material made by the method of claim 1.

19. A lithium-ion battery including the lithium-ion battery cathode of claim 18.
